(19) United States
(12) Patent Application Publication
(10) Pub. No.: US 2018/0010782 A1
(43) Pub. Date: Jan. 11, 2018

(54) LED LUMINAIRE

(71) Applicant: MG2 TECHNOLOGIES, LLC, Danvers, MA (US)

(72) Inventor: Miguel GALVEZ, SR., Danvers, MA (US)

(21) Appl. No.: 15/410,066

(22) Filed: Jan. 19, 2017

Related U.S. Application Data
(60) Provisional application No. 62/280,152, filed on Jan. 19, 2016.

(51) Int. Cl. F21V 7/06

(52) U.S. Cl. CPC F21V 29/773; F21V 7/06; F21K 9/68; F21Y 2115/10

(57) ABSTRACT

An LED luminaire comprising a housing, a chamber with an internal cavity formed by a wall, a plurality of LED lamps mounted around at least a portion of the inner wall surface, and a plurality of heat sink elements mounted around at least a portion of the outer wall surface.

### CROSS REFERENCE TO RELATED APPLICATION

This application claims priority to co-pending U.S. Provisional Patent Application No. 62/280,152, filed Jan. 19, 2016, and commonly assigned to the assignee of the present application, the disclosure of which is incorporated by reference in its entirety herein.

### FIELD

The present disclosure relates, in exemplary embodiments, to LED lighting fixtures.

### BACKGROUND

Outdoor lighting for illuminating various areas, such as, but not limited to, streets, recreational areas, parking lots, as well as interior and industrial spaces that utilize high power LEDs (light-emitting diodes) as light sources, require not only significant cooling area to maintain the LED junction temperature below 120° C., but also require secondary optics to aim the light in the desired candela distribution for the specific application. The amount of heat sink required is based on the way that all LEDs are arranged in the light source. Commonly, the LEDs are concentrated in the central section of the luminaire or placed over two-dimensional flat surfaces with some sort of distribution to accommodate the secondary optics. These two constraints makes current LED fixture designs not only heavy and bulky structures to handle the heat produced by the LEDs, but, by also utilizing secondary optics, reduce the total lumen-per-watt efficiency of the light source and cost.

It would be desirable to have a fixture that can not only obviate the thermal management constrains of the street lighting fixture by having a lighter structure, but also accomplish the candela distribution and reduced glare without additional secondary optics. Such a fixture would be more efficient and less heavy than currently available fixtures.

### SUMMARY

In one exemplary embodiment, an LED luminaire is provided comprising a housing; a chamber defined in the housing and having a wall defining a cavity within the chamber, the wall comprising an inner wall surface and an outer wall surface, the cavity also having a central area; a plurality of heat sink elements projecting from and spaced at least partially around the outer wall surface; and, a plurality of LED lamps associated with and spaced around at least a portion of the inner wall surface, each LED lamp being positioned to face generally toward the central area. In exemplary embodiments, the chamber inner wall has either a complex parabolic reflector shape or an oval shape. In exemplary embodiments, the plurality of heat sink elements are a plurality of fins. In exemplary embodiments, each heat sink element on the outer wall surface has at least one LED lamp positioned on the inner wall surface corresponding generally to a position proximate thereto. In exemplary embodiments, each heat sink element on the outer wall surface has at least one LED lamp positioned on the inner wall surface corresponding generally to a position between two heat sink elements.

### BRIEF DESCRIPTION OF THE DRAWINGS

The drawings disclose exemplary embodiments in which like reference characters designate the same or similar parts throughout the figures of which:

FIG. 1 shows a side schematic view of one exemplary embodiment of a design for an optical chamber for axis-symmetric revolution of a complex parabolic reflector.

FIG. 2 shows a perspective view of the embodiment of FIG. 1.

FIG. 3 shows a perspective view of an optical cavity according to one exemplary embodiment.

FIG. 4 shows a perspective schematic view of the cooling fins according to one exemplary embodiment.

FIG. 5 is a perspective schematic view of cooling fins and LEDs according to one exemplary embodiment.

FIG. 6 is a graph of the candela distribution of one exemplary embodiment of a light fixture where the LEDs are placed at the bottom of the fins.

FIG. 7 is a graph of the candela distribution of one exemplary embodiment of a light fixture where the LEDs are placed at half way between the length of the fin to control the optical light distribution. Changing the placement of the LED will change the light distribution accordingly.

FIG. 8 is a perspective view of an exemplary embodiment having LEDs surface mounted on a flexible board.

FIG. 9 is a top plan view of one exemplary embodiment of a circular light source.

FIG. 10 is a perspective view of one exemplary embodiment of a light fixture used in a cobra head retrofit design.

FIG. 11 is a perspective view of one exemplary embodiment of a light fixture used in a cobra head for narrow streets.

FIG. 12 is a perspective view of one exemplary embodiment of a light fixture used in an avenue street light fixture with a double light source.

FIG. 13 is a perspective view of one exemplary embodiment of a light fixture used in a dawn-to-dusk retrofit light.

FIG. 14 is a perspective view of one exemplary embodiment of a light fixture used in a flood light.

FIG. 15 is a perspective view of one exemplary embodiment of a light fixture used in a “shoe box” type fixture.

FIG. 16 is a perspective view of one exemplary embodiment of a light fixture used in a “high bay” lamp fixture.

FIG. 17 is a perspective view of one exemplary embodiment of a light fixture for indoor lighting.

FIG. 18A is a side perspective view of a conventional 26 watt, 56 lumens/watt, 1.6 lb. fixture design in the prior art.

FIG. 18B is a side perspective view of a 26 watt, 56 lumens/watt fixture design according to one exemplary embodiment, but which weighs only 0.5 lb.

FIG. 19A is a perspective view of a conventional 50 watt, 90 lumens/watt, 25 lb. fixture design in the prior art.

FIG. 19B is a bottom plan view of a 50 watt, 90 lumens/watt fixture design according to one exemplary embodiment, but which weighs only 7 lb.

### DETAILED DESCRIPTION

Unless otherwise indicated, the drawings are intended to be read (for example, cross-hatching, arrangement of parts, proportion, degree, or the like) together with the specification, and are to be considered a portion of the entire written description of this invention. As used in the following description, the terms “horizontal”, “vertical”, “left”, “right”, “up” and “down”, “upper” and “lower” as well as adjectival and adverbial derivatives thereof (for example, “horizontally”, “upwardly”, or the like), simply refer to the orientation of the illustrated structure as the particular drawing figure faces the reader. Similarly, the terms “inwardly” and “outwardly” generally refer to the orientation of a surface relative to its axis of elongation, or axis of rotation, as appropriate.

The presently disclosed fixture can be used in luminaires utilized in, for example, street lighting, indoor lighting, industrial lighting, recreational areas, parking places and the like. In exemplary embodiments, a luminaire-fixture has an optical chamber with walls or surfaces having very high reflectivity that produces the desired candela distribution without secondary optics. In exemplary embodiments, the fixture includes a set of LED-dedicated fins that manage the heat produced by the LED lamps (referred to as LEDs) to keep their operating solder point temperature below about 40° C. with only using natural convection and radiative cooling.

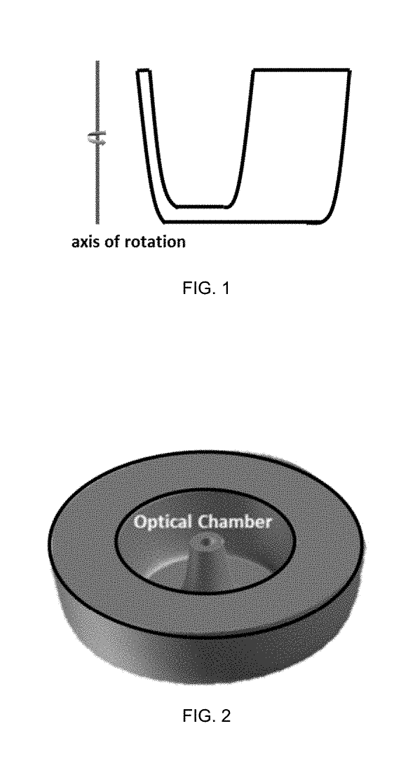

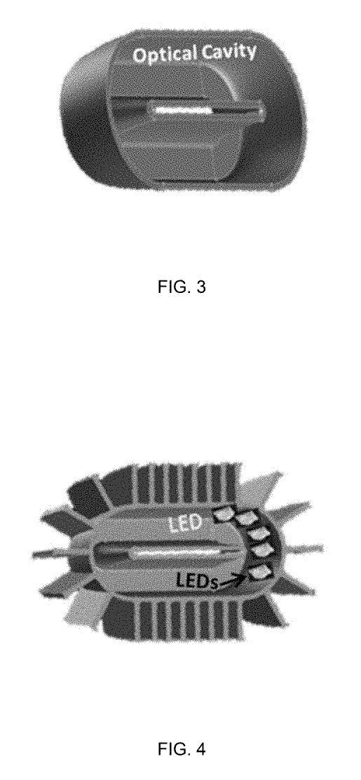

One exemplary embodiment of a LED luminaire according to the present disclosure comprises an optical chamber with a geometry formed by axis-symmetric revolution of a complex parabolic reflector (CPR) shape as shown in FIGS. 1 and 2 (for a spot-type illumination). In another exemplary embodiment, the optical chamber has a geometry formed by extrusion along the periphery of a race track of a CPR shape, such as that as shown in FIG. 3 (for an elongated oval light distribution) and with cooling fins and LEDs (FIG. 4).

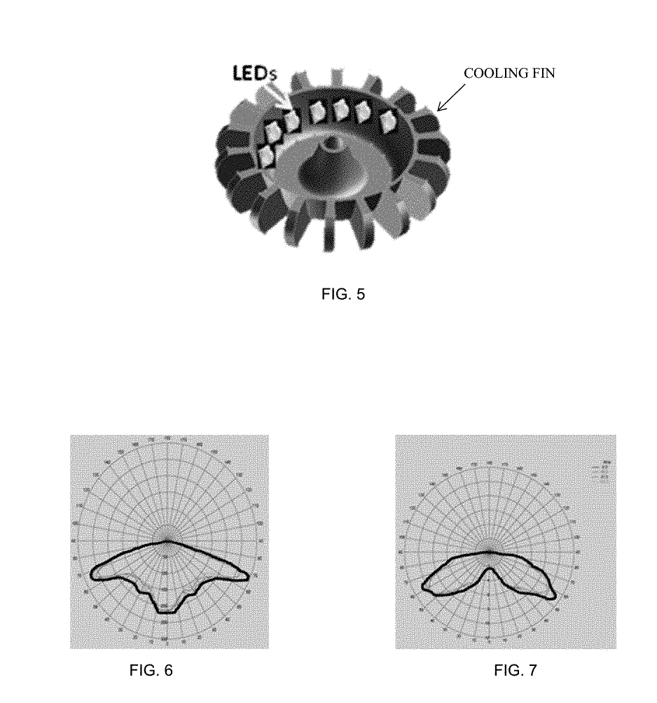

The LEDs are placed on the internal outer wall surface of the CPR, facing towards the inner surface, for example (for spot-type illumination) as shown in FIG. 5. A feature of the presently disclosed fixtures is the positioning of the LEDs. The LEDs are facing inward and mounted on the internal outer wall of the optical cavity. Each LED is mounted adjacent (i.e., a position on the internal outer wall corresponding) to a cooling fin positioned on the exterior outer wall, as shown in the exemplary embodiments of FIGS. 2 and 4.

The optical cavity is embedded in a fin-like circular/oval structure, where each fin handles the thermal management of a single LED or a set of LEDs. By placing the LEDs in this manner, the light distribution produced in the far field of FIG. 1 will depend of the positioning of the LEDs along the outer surface of the optical chamber without the requirements of secondary optics.

In exemplary embodiments, the candela distribution obtained from a ray tracing program is shown in FIGS. 6 and 7, for two positions of the LEDs without the help of secondary optics. FIG. 6 shows candela distribution of an exemplary light fixture where the LEDs are placed at the bottom and FIG. 7 shows the distribution where the LEDs are placed half way around the fin structure to the outer surface of the optical cavity. The beam angle can be shaped by changing the aperture of the complex parabolic reflector/diffuser. The wider the aperture of a single branch parabola will produce a larger aperture beam. Hence a secondary optics is not required to accomplish the light distribution.

A feature of the presently disclosed fixture is that by placing the LEDs pointing inwards to the inner surface of the optical cavity, the LED bulbs will not readily be seen directly when a person is facing the optical cavity consequently glare may be reduced.

Another feature of the presently disclosed fixture is that by placing the LEDs on the outer surface, a ring-like layout of thermal-fins-heat sink with dedicated fins for each LED can be achieved, as shown in the exemplary embodiment of FIG. 2.

Accordingly, thermal performance can be achieved for individual LEDs resulting in a less massive fixture than is currently commercially available.

The sides of the fins are natural convection cooled by air flowing upwards as well as by radiative cooling of the fins. These fins, when painted black, emit thermal radiation close to 1.0, achieving maximum radiative cooling.

Having the LEDs positioned in the radial direction allows the positioning of more LEDs. This feature allows the fixture to be scaled from low LED wattage lamps to large LED wattage lamps without compromising heat management.

The natural convection cooling fins are tailored for each individual LED, hence the fin sizes are optimized to the smallest size and are cooled by natural convection so that the LEDs do not exceed temperatures of about 60° C. when operated at rated power.

In exemplary embodiments, fins having a size of 1 inch×1 inch×1/8 inches for a 1 Watt LED keep the LED temperature below about 35° C. In exemplary embodiments, fins having a size of 1.5 inches×1 inch×⅛ inches for a 1 Watt LED keep the LED temperature below about 30° C. In exemplary embodiments, fins having a size of ¾ inches×1 inch×⅛ inches for a 1 Watt LED keep the LED temperature below about 40° C. Accordingly, the fins can be sized in accordance with LED wattage.

The light fixtures of the present invention can be configured in various ways depending on how the LEDs are positioned in the inner cavity, such as is illustrated in FIG. 2.

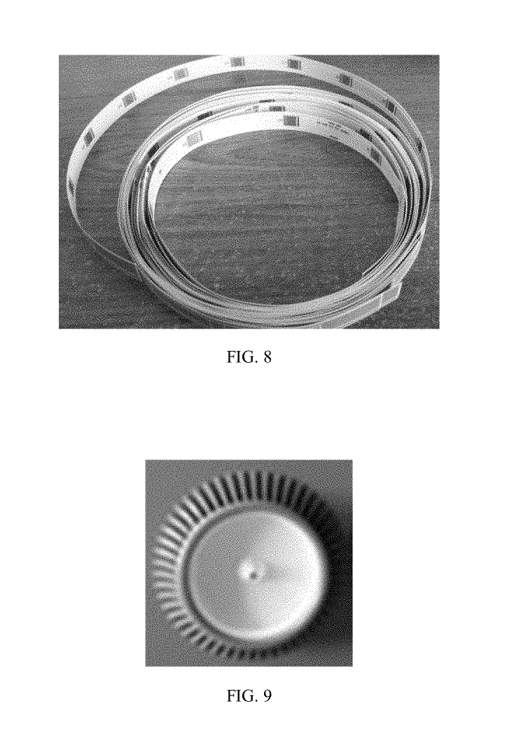

In one exemplary embodiment, the LEDs are surfaced mounted on a flexible board, as shown in FIG. 8. The length of the flexible board can be 27πr, where r is the radius to the axis of rotation of the outer parabola. The flexible board is attached to the inner side of the outer wall. In exemplary embodiments the board can be attached with a thermal conductor double tape, thermal epoxy, other adhesive, or by other fastening means known to those skilled in the art.

In exemplary embodiments, the fixture can be made of aluminum (or other thermal conductor metals or ceramics or plastics) casted, machined, injection molded, or by other manufacturing processes known to those skilled in the art.

The cavity of the fixture which is referred to as the optical cavity, can be spray painted or coated with high reflective resins or clear epoxies that contains alumina (Al₂O₃) or TiO₂. Alternatively, the fixture can be made of a thermoplastic material or materials which has the aforementioned high reflective material coated or painted thereon or incorporated therein (e.g., impregnating, laminating, or the like). The hollow center of the complex parabola of revolution is used to enhance the convection cooling of the lamp fixture.

In exemplary embodiments, the LEDs are mounted first in individualized fin heat sinks as shown FIG. 4. The aluminum thermal fins are cast, machined, or injection molded (or by other method known to those skilled in the art) individually. The fins can be made of high thermal conductor metals, plastics or ceramics. Each fin can be made of alumina, cooper or other high thermal conductivity material, and is dedicated to each LED to maintain LED temperature below about 40° C.

In exemplary embodiments, the present disclosure provides high power (such as greater than about 50 Watt) LED fixtures with only convection cooling by designing thermal fins that are dedicated to individual or a set of LEDs. Furthermore, if the optical cavity is made by axis-symmetric revolution or extrusion along oval paths of a complex parabolic reflector, as illustratively described in FIG. 1 and FIG. 2, prescribed candela distribution can be obtainable without secondary optics.

In exemplary embodiments, the optical cavity can be formed of a composite parabola of an axis-symmetric revolution of a complex parabolic reflector or an oval or race track shape extruded composite parabola. The optical cavity can be spray painted or coated with high reflectivity optical (>96%) materials. Alternatively, the cavity can be made of injection molded thermoplastic material or materials that already include high reflectivity optical material. The cavity is surrounded by thermally designed fins. Where each fin is dedicated to a single LED or a set of LEDs. The LEDs are placed on the inside of the outer parabola. The LEDs face the inner surface of the inner parabola. The candela distribution can be tailored by moving the LEDs up or down the outer wall of the optical cavity. The angular candela distribution can be further modified by changing the aperture and inclination of the parabola of revolution. A smaller composite parabola aperture leads to a narrower candela distribution or beam angle. The number of LEDs is mainly prescribed by the perimeter of the outer parabola of the optical cavity, namely by 27πr, where r is the radius to the axis of rotation of the outer parabola. The central part of the open section formed when the composite parabola is revolved or extruded contributes to the cooling of the lamp fixture. This radial distribution of LEDs reduces the glare of the lamp. This radial distribution also allows for placing more LEDs for high power applications without sacrificing size of fixture or thermal management.

One exemplary embodiment, shown in FIG. 9, illustrates a circular light source. This embodiment includes an optical chamber (white color) and central reflector core (conical shape in this example) to shape the light distribution by reflecting the light from the pointing inward LEDs. The dedicated thermal fins are for thermal management. A cover protects the LEDs and the optical chamber from debris. A ring with a gasket holds the cover in place in a generally water-tight manner to prevent the intrusion of water. Each fin has an LED package that points inwards toward the optical chamber. In this exemplary embodiment, the fixture has 50 fins, which means that there are 50 LED packages. This light source handle all the heat the LEDs produces, keeping the LED temperature below about 40° C. relative to the ambient temperature. For instance, if the ambient temperature is 21° C., then the temperature at steady state will be 61° C.

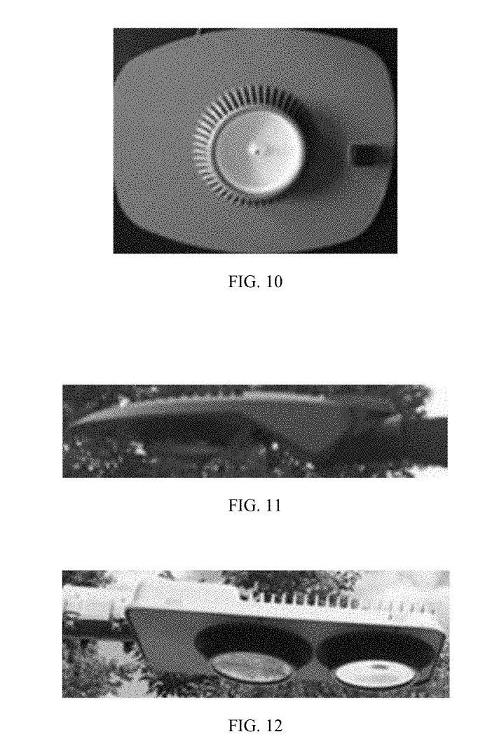

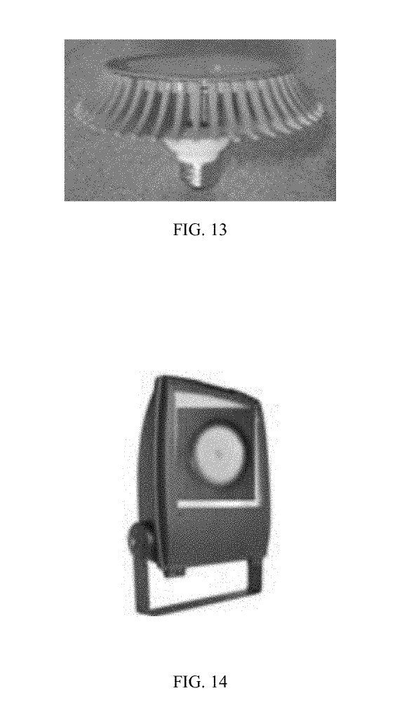

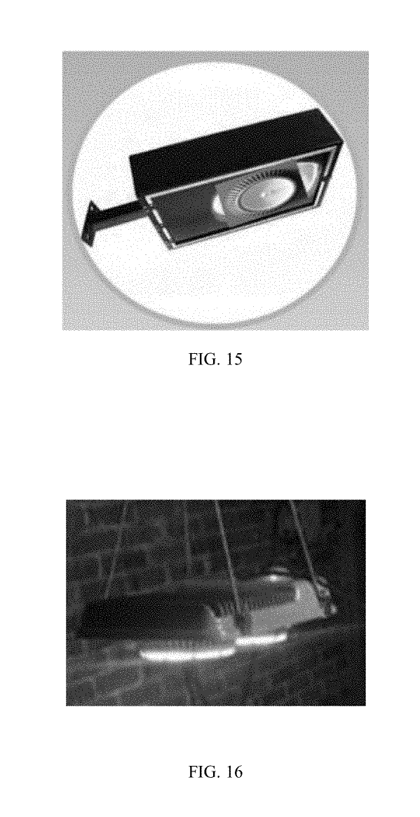

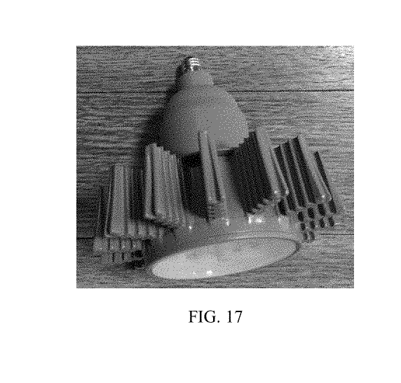

Exemplary embodiments of the light source can be utilized for other applications or embodiments for various applications, as shown in FIGS. 10-16. FIG. 10 shows a cobra head retrofitted with a light fixture as described herein. FIG. 11 shows a cobra head design for narrow streets. FIG. 12 shows an avenue street fixture with a double light source. FIG. 13 shows a dawn-to-dusk retrofit light. FIG. 14 shows a flood light. FIG. 15 shoes a shoe box design. FIG. 16 shows a high bay design. FIG. 17 is a perspective view of one exemplary embodiment of a light fixture for indoor lighting. In this embodiment, the back of the lamp can be changed to fit existing sockets.

It is to be understood that other shapes and configurations are contemplated as being within the scope of the presently disclosed invention.

As shown above, this new art empowers the LED light sources to have a one type of light source for multiple applications. The fixtures are only use as holders for the light source and to hidden the cables and driver convertors and not for sinking/spreading the heat produced for the light source.

A feature of the presently disclosed invention is that the number of LEDs can be maximized in small areas and be cooled by natural convection instead of active cooling (i.e., the use of fans) that is commonly used in conventional designs. For applications of the same LED wattage, the presently disclosed embodiments can have fixtures that have reduced weight because the need for cooling fans is eliminated. Also, for fixtures as presently disclosed versus common conventional fixtures of the same wattage, dimensions and weight, the lumens from fixtures constructed as presently disclosed will be greater because the LEDs of the presently disclosed designs will be operating at a lower temperature. The difference in operating temperature can lead to an increase in lumen output of at least about 10% or more compared to conventional fixtures.

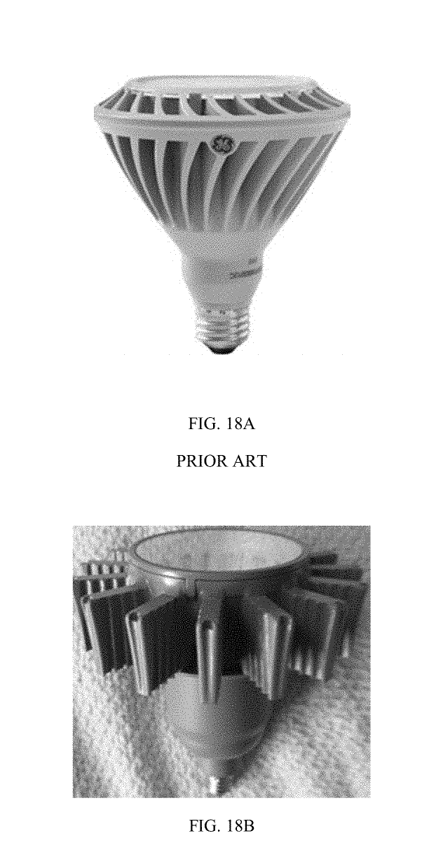

FIG. 18A shows a conventional 26 watt, 56 lumens/watt, 1.6 lb. fixture design. FIG. 18B shows a 26 watt, 56 lumens/watt fixture design according to one exemplary embodiment, but which weighs only 0.5 lb.

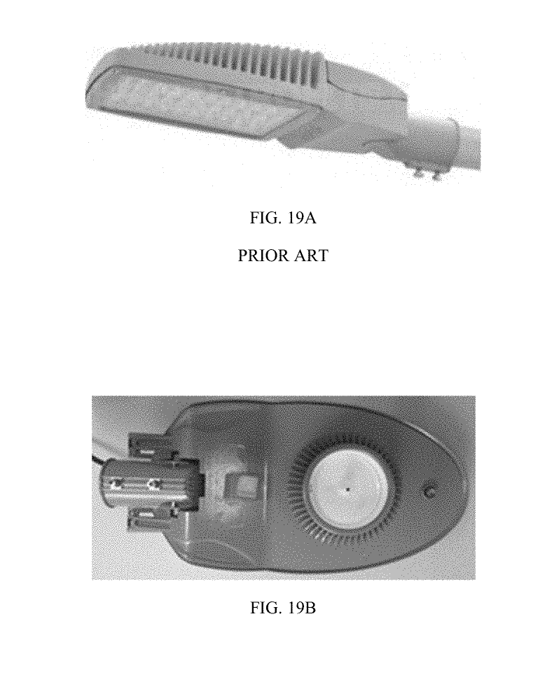

FIG. 19A shows a conventional 50 watt, 90 lumens/watt, 25 lb. fixture design. FIG. 19B shows a 50 watt, 90 lumens/watt fixture design according to one exemplary embodiment, but which weighs only 7 lb.

Although only a number of exemplary embodiments have been described in detail above, those skilled in the art will readily appreciate that many modifications are possible in the exemplary embodiments without materially departing from the novel teachings and advantages. Accordingly, all such modifications are intended to be included within the scope of this disclosure as defined in the following claims.

While the methods, equipment and systems have been described in connection with specific embodiments, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

It should further be noted that any patents, applications and publications referred to herein are incorporated by reference in their entirety.

I claim:

1. An LED luminaire, comprising:
a. a housing;
b. a chamber defined in the housing and having a wall defining a cavity within the chamber, the wall comprising an inner wall surface and an outer wall surface, the cavity also having a central area;
c. a plurality of heat sink elements projecting from and spaced at least partially around the outer wall surface;
d. a plurality of LED lamps associated with and spaced around at least a portion of the inner wall surface, each LED lamp being positioned to face generally toward the central area.

2. The LED luminaire of claim 1, wherein the chamber inner wall has either a complex parabolic reflector shape or an oval shape.

3. The LED luminaire of claim 1, wherein the plurality of heat sink elements are a plurality of fins.

4. The LED luminaire of claim 1, wherein each heat sink element on the outer wall surface has at least one LED lamp positioned on the inner wall surface corresponding generally to a position proximate thereto.

5. The LED luminaire of claim 1, wherein each heat sink element on the outer wall surface has at least one LED lamp positioned on the inner wall surface corresponding generally to a position between two heat sink elements.
